(19) United States
(12) Patent Application Publication
(10) Pub. No.: US 2013/0254501 A1
(43) Pub. Date: Sep. 26, 2013

(54) STORAGE APPARATUS AND DATA STORAGE METHOD

(71) Applicants: Masayuki Kishi, Hiratsuka (JP); Yasunori Sato, Yokosuka (JP)

(72) Inventors: Masayuki Kishi, Hiratsuka (JP); Yasunori Sato, Yokosuka (JP)

(73) Assignees: HITACHI COMPUTER PERIPHERALS CO., LTD., Ashigarakami-gun, Kanagawa (JP); HITACHI, LTD., Tokyo (JP)

(21) Appl. No.: 13/510,777

(22) PCT Filed: Mar. 23, 2012
(86) PCT No.: PCT/JP2012/057561

§ 371 Date: May 18, 2012

(51) Int. Cl. G06F 12/16

(52) U.S. Cl. 711/162; 711/E12.103

(57) ABSTRACT

A storage apparatus executes a duplication determination, which is a determination as to whether or not a second data, which is identical to a first data stored in a first file system, exists in a second file system, in a case where a migration process for migrating the first data to the second file system is to be performed, executes the migration process in a case where the result of the duplication determination is negative, and does not execute the migration process in a case where the result of the duplication determination is affirmative.

### TECHNICAL FIELD

The present invention relates to technology for a storage apparatus and a data storage method.

### BACKGROUND ART

For example, relatively large-scale storage apparatuses are used to manage data at government organizations, corporations, educational institutions and the like where huge amounts of data of different types are handled. This storage apparatus comprises at least one storage control apparatus. The storage control apparatus, for example, comprises a large number of storage devices, and is able to provide a storage area based on RAID (Redundant Array of Inexpensive Disks). At least one or more logical devices (also called logical storage) are formed on a physical storage area provided by a storage device group. A host computer (will be referred to as “host” hereinafter) performs a data write or a data read by issuing a “write” request or a “read” request to a logical device.

Furthermore, a storage apparatus, which comprises a duplicate removal process for removing identical data stored redundantly, is known. For example, Patent Literature 1 discloses a storage apparatus, which executes a duplicate removal process using data acquired from outside by a data acquisition part and additional information and address information stored in an information storage part.

### CITATION LIST

### Patent Literature

### [PTL 1]

Japanese Patent Application Laid-open No. 2001-191933

### SUMMARY OF INVENTION

### Technical Problem

The invention disclosed in the Patent Literature 1 must store data received from outside in a storage device 25 after performing a duplicate removal process. Therefore, in the invention disclosed in the Patent Literature 1, there is the likelihood of the processing load of this duplicate removal process lowering the write performance and the read performance of the storage apparatus as a whole.

### Solution to Problem

A storage apparatus comprises a first file system, a second file system, and a controller for controlling the first file system and the second file system. The controller (A) executes a duplication determination, which is a determination as to whether or not a second data, which is identical to a first data stored in the first file system, exists in the second file system in a case where a migration process for migrating the first data to the second file system is to be performed. Then, in a case where the result of the duplication determination of (A) above is negative, the controller executes the migration process, and in a case where the result of the duplication determination in (A) above is affirmative, does not execute the migration process.

### BRIEF DESCRIPTION OF DRAWINGS

FIG. 1 is a schematic diagram for illustrating a duplicate removal process at the time of a migration.

FIG. 2 is a block diagram showing an example of the hardware configuration of a storage apparatus 10.

FIG. 3 is a block diagram showing an example of the function configuration and the configuration of the storage apparatus 10.

FIG. 4 is a diagram showing the data configuration of each file.

FIG. 5 is examples of ContentID 301, ChunkSetID 304 and FingerPrint 305 values.

FIG. 6 is a schematic diagram for illustrating a Stub restoration process.

FIG. 7 is a flowchart showing an example of a write process.

FIG. 8 is a flowchart showing an example of a partitioned Chunk process.

FIG. 9 is a flowchart showing an example of an output process to a ContentTable file.

FIG. 10 is a flowchart showing an example of a read process.

FIG. 11 is a flowchart showing an example of a Chunk read process.

FIG. 12 is a flowchart showing an example of a ContentTable restoration process.

FIG. 13 is a flowchart showing an example of a Log file process.

FIG. 14 is a flowchart showing an example of a first TEMP file process.

FIG. 15 is a flowchart showing an example of a ChunkSetIndex restoration process.

FIG. 16 is a flowchart showing an example of a second TEMP file process.

FIG. 17 is a flowchart showing an example of a duplicate management restoration process.

FIG. 18 is a flowchart showing an example of a third TEMP file process.

### DESCRIPTION OF EMBODIMENTS

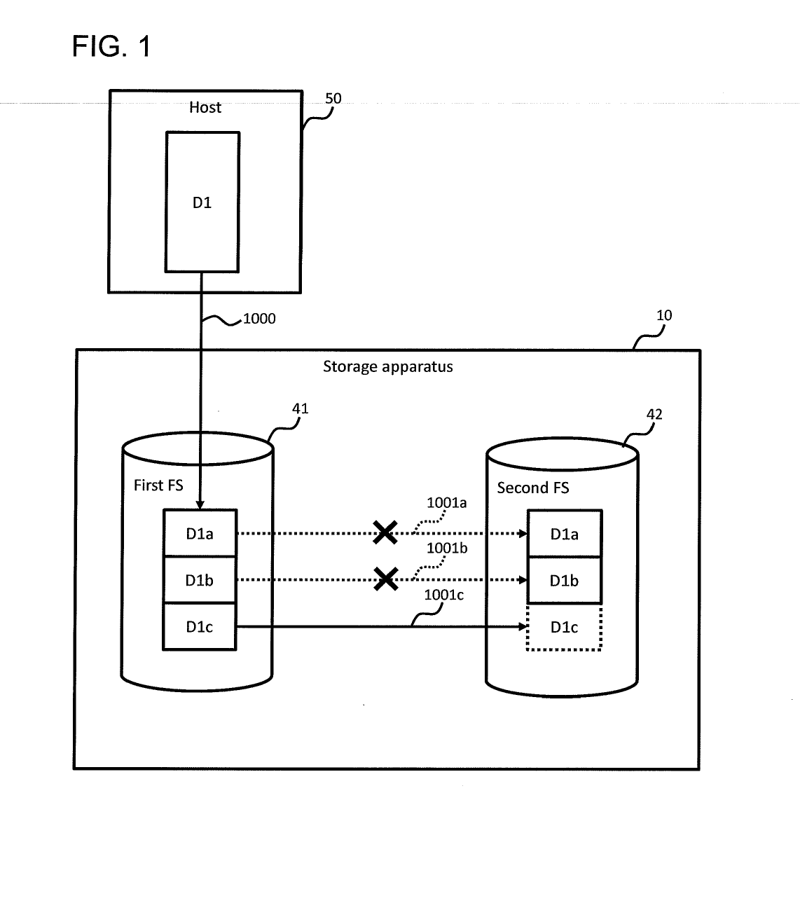

FIG. 1 is a schematic diagram for illustrating a duplicate removal process at the time of a migration. An overview of the duplicate removal process related to this example will be explained below using FIG. 1.

A storage apparatus 10 comprises a first file system and a second file system, which are accessible from a computer. The storage apparatus 10, upon receiving a data D1 write request from a host 50 (1000), first stores this data D1 in the first file system (hereinafter referred to as “first FS”) 41. Then, the storage apparatus 10 moves the data D1 stored in the first FS41 to the second file system (hereinafter referred to as “second FS”) 42 at a prescribed timing. The moving of the data stored in the first FS 41 to the second FS 42 is called a migration. The prescribed timing, for example, is when the overall processing load on the storage apparatus is small, or when the amount of data stored in the first FS 41 becomes equal to or larger than a prescribed amount. This makes it possible for the storage apparatus 10 to shorten the write response time with respect to the host 50.

The storage apparatus 10 related to this example performs a duplicate removal process when a migration is executed. An overview of this duplicate removal process will be described below.

When a migration is to be executed, the storage apparatus 10 partitions this data D1 into data D1a, data D1b, and data D1c of a prescribed size. This partitioned data is referred to as “Chunk data”. Then, the storage apparatus 10 searches whether this Chunk data D1a through D1c is already stored in the second FS 42. Then, the storage apparatus 10 identifies the fact that Chunk data D1a and D2b are already stored in the second FS 42, and that data D2c is not stored in the second FS 42 yet. Consequently, the storage apparatus 10 migrates only the Chunk data D1c (1001c), which is not yet stored in the second FS 42, without migrating Chunk data D1a and D1b (1001a, 1001b), which are already stored in the second FS 42. In accordance with this, the Chunk data D2a and D2b are not redundantly stored in the second FS 42. Therefore, the user can make efficient use of the storage capacity of the storage apparatus 10. Hereinbelow, data may also be referred to as a file. In addition, Chunk data may be called segment data or a sub-file.

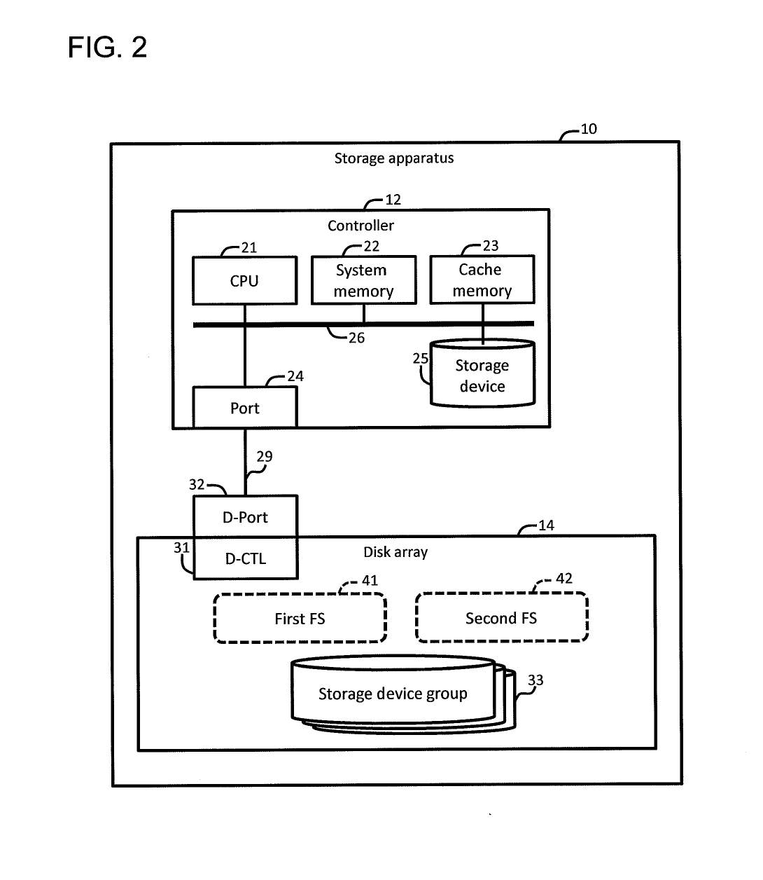

FIG. 2 is a block diagram showing an example of the hardware configuration of the storage apparatus 10.

The storage apparatus 10 comprises a controller 12 and a disk array 14. The controller 12 and the disk array 14 are coupled via a cable 29. There may be multiple controllers 12.

The controller 12 controls the disk array 14. For example, the controller 12, on the basis of a write request sent from the host 50, writes a prescribed data to a storage device group 33 comprising the disk array 14. For example, the controller 12, on the basis of a read request sent from the host 50, reads a prescribed data from the storage disk group 33 comprising the disk array 14. The controller 12 comprises a CPU 21, a system memory 22, a cache memory 23, a storage device 25, and a Port 24, and the respective components 21 through 25 are coupled via a bus 26, which enables two-way communications.

The CPU (Central Processing Unit) 21 executes a process included in a computer program (referred to as “program” hereinafter), and realizes a variety of functions, which will be explained further below.

The system memory 22 can store data while power is being supplied. Since the system memory 22 is able to read and write data relatively fast, for example, it is used as a temporary storage area for data being used by the CPU 21. The memory, for example, comprises DRAM (Dynamic Random Access Memory) or the like.

The cache memory 23 temporarily stores data, which has been sent together with a write request from the host 50, and data, which has been read from the disk array 14, as a cache. In accordance with this, the write performance and read performance are enhanced with respect to the host 50. The cache memory 23, for example comprises DRAM or the like.

The storage device 25 can store data even while power is not being supplied. Therefore, the storage device 25, for example, stores a program executed by the CPU 21, and setting information required when this program is executed. The storage device 25, for example, comprises either a HDD (Hard Disk Drive) or a flash memory or the like.

A cable 29, which enables data to be sent and received in two directions, is coupled to the Port 24, and this cable 29 is coupled to the disk array 14. That is, the controller 12 can send/receive data to/from the disk array 14 via the Port 24.

The disk array 14 comprises a D-Port 32, a D-controller (referred to as “D-CTL” hereinafter) 31, and multiple storage devices (referred to as “storage device group” hereinafter) 33.

The cable 29, which enables data to be sent and received in two directions, is coupled to the D-Port 32, and this cable 29 is coupled to the controller 12. That is, the disk array 14 can send/receive data to/from the controller 12 via the D-Port 32.

The D-CTL 31 controls the data being sent and received via the D-Port 32. For example, the D-CTL 31 writes data to the storage device group 33 and reads data from the storage device group 33 based on control information received from the D-Port 32.

The storage device group 33 comprises multiple physical storage devices, which are capable of storing data even while power is not being supplied. The disk array 14 controls this storage device group 33, and can build arbitrary logical FS on this storage device group 33. That is, the disk array 14 is able to build an arbitrary number of logical FS have arbitrary capacity without being constrained by the physical storage capacity of the individual storage devices 25. The disk array 14, for example, is able to build the first FS 41 and the second FS 42 on the storage device group 33 as shown in FIG. 2.

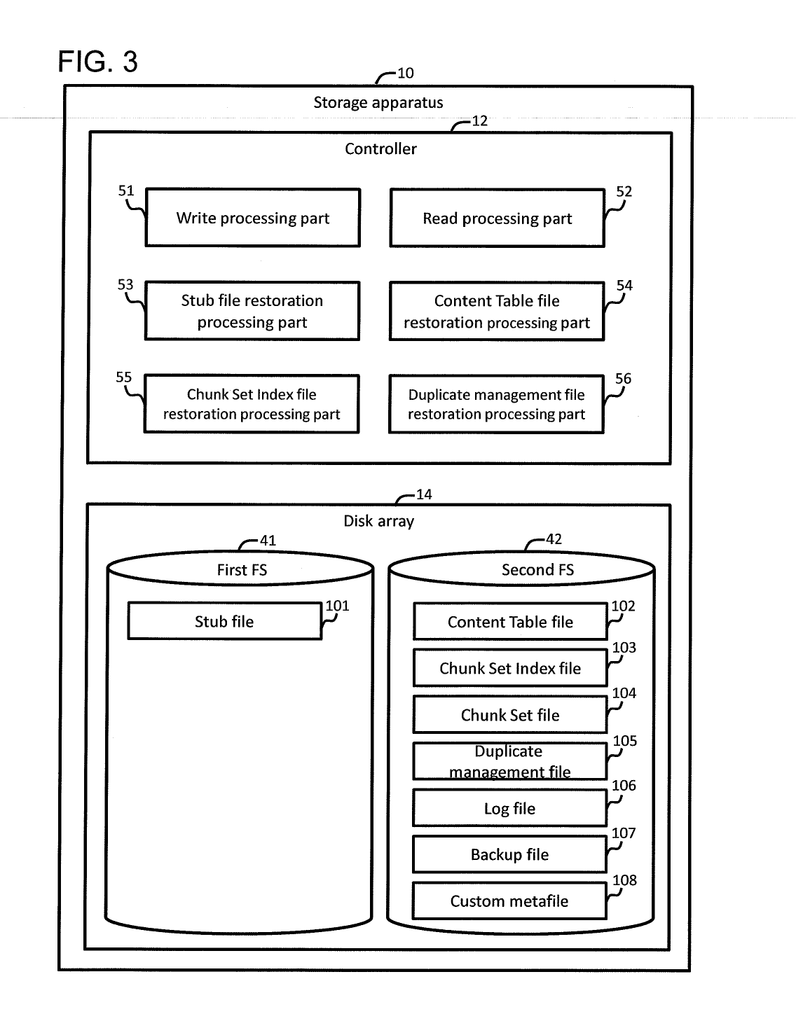

FIG. 3 is a block diagram showing an example of the function configuration and the data configuration of the storage apparatus 10.

The controller 12 comprises a write processing part 51, a read processing part 52, a Stub restoration processing part 53, a ContentTable (referred to as “CT” hereinafter) restoration processing part 54, a ChunkSetIndex (referred to as “CSIndex” hereinafter) restoration processing part 55, and a duplicate management restoration processing part 56. The disk array 14 comprises the first FS 41 and the second FS 42. The first FS 41 stores a Stub file 101. The second FS 42 stores a CT file 102, a CSIndex file 103, a CS file 104, a duplicate management file 105, a Log file 106, a backup file 107, and a custom metafile 108.

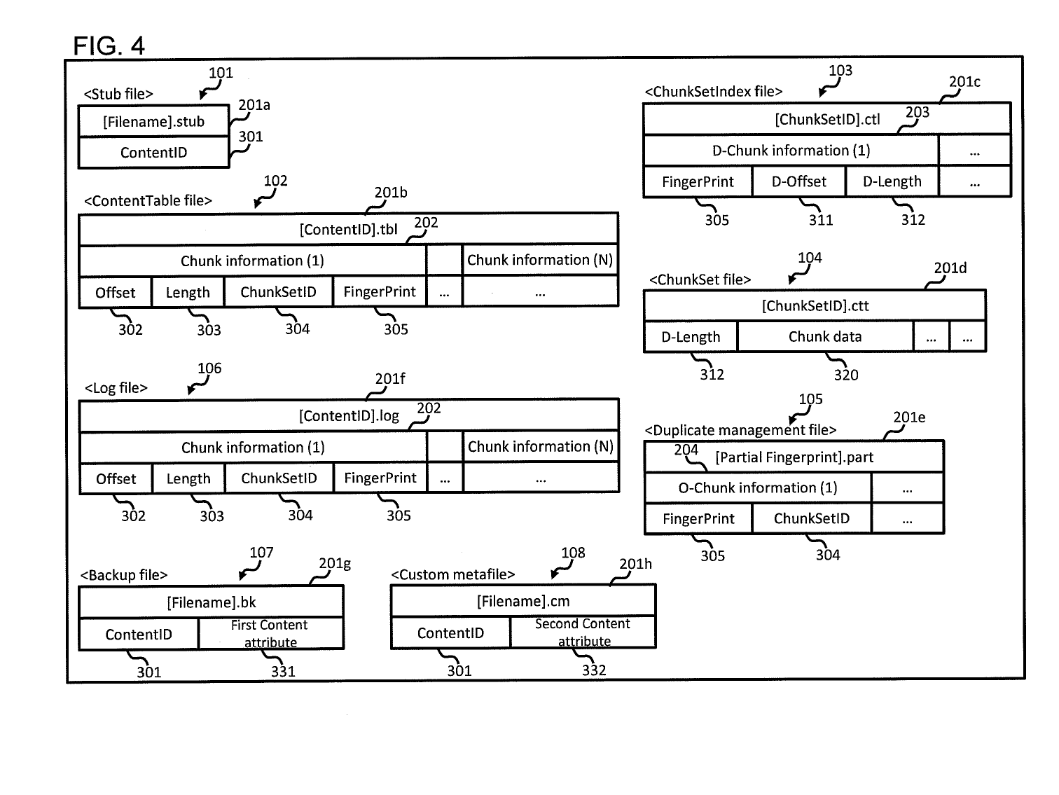

FIG. 4 is a diagram showing the data configuration of each file. First, the files 102 through 108 described above will be explained.

The Stub file 101 comprises metadata for accessing data, which is actually stored in the second FS 42. Data, which was stored in the first FS 41 one time, is deleted from the first FS 41 at a prescribed timing upon being migrated to the second FS 42. However, a Stub file 101 for referencing the data, which has been migrated to the second FS 42, is stored in the first FS 41. Therefore, the controller 12 is able to access the data, which has been migrated to the second FS 42, by referencing Stub file 101 of the first FS 41.

The Stub file 101, for example, is stored in the first FS 41 under a filename 201a, such as “‘filename’.Stub”. As a data item, the Stub file 101 comprises a ContentID 301, which makes it possible to uniquely identify data actually stored in the second FS 42. The value of the ContentID 301, for example, is created using a UUID (Universally Unique Identifier).

The CT file 102 comprises information for reconfiguring partitioned Chunk data 320 in a source file. The CT file 102, for example, is stored in the second FS 42 under a filename 201b such as “‘ContentID’.tb1”. Therefore, the controller 12 is able to retrieve a CT file 102 comprising a ContentID, which is the same as that of the Stub file 101.

The CT file 102 comprises an Offset 302, a Length 303, a ChunkSetID 304, and a FingerPrint (referred to as “FP” hereinafter) 305 as data items for each partitioned Chunk data 320. Information comprising these data items 302 through 305 is referred to as Chunk information 202. The CT file 102 comprises Chunk information 202 in a sequence for configuring the source file. The respective data items of the Chunk information 202 will be explained below.

The Offset 302 shows a value (for example, an address value), which is offset from the start of the CT file 102. That is, the Offset 302 is information showing the sequence of the Chunk information 320 when reconfiguring the source file.

The Length 303 is information showing the total data size of the ChunkSetID 304 and the FP 305.

The ChunkSetID 304 is an ID, which makes a CSIndex file 103 and a CS file 104 uniquely identifiable. That is, by referencing the value of this ChunkSetID 304, it is possible to identify the CSIndex file 103 and the CS file 104 corresponding to this Chunk data 320. The ChunkSetID 304, for example, is created using a UUID.

The FP 305 is a value, which is uniquely computed from the Chunk data 320 using a prescribed formula. The FP 305, for example, is a hash value computed from the Chunk data 320 using a hash function.

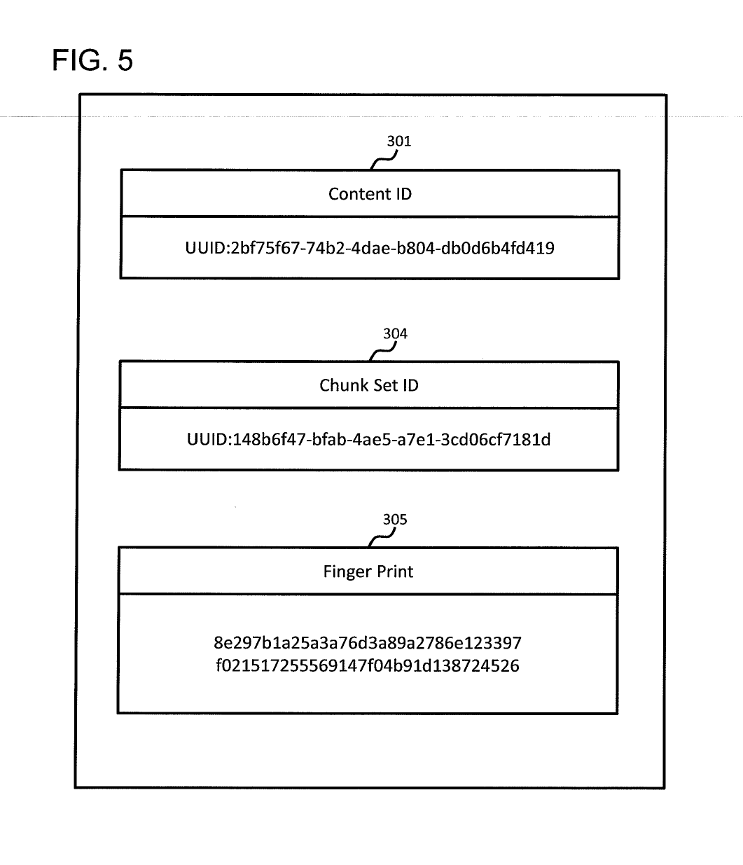

FIG. 5 is an example of values of the ContentID 301, the ChunkSetID 304, and the FP 305.

The ContentID 301 and the ChunkSetID 304, for example, comprise UUID values like those shown in FIG. 5. The FP 305, for example, comprises a hash value like that shown in FIG. 5. The explanation will return to FIG. 4 below.

The Log file 106 is used when restoring a CT file 102. The Log file 106 corresponds on a one-to-one basis with the CT file 102, and, for example, is stored in the second FS 42 under a filename 201f such as “‘ContentID’.log”. The Log file 106 fundamentally comprises the same data items as the CT file 102. However, the sequence of the Chunk information 202 in the Log file 106 can differ from that of the CT file 102. That is, the Log file 106 does not necessarily store the Chunk information 202 in Offset 302 sequence. The reason for this is as follows.

There may be cases in which the migration of Chunk data 320 to the second FS 42, for example, is executed as multitasking, and as such, is not necessarily performed in the sequence of the Offsets 302. However, the Chunk information 202 is recorded in the Log file 106 in the sequence in which the Chunk data 320 was migrated to the second FS 42. Therefore, the Chunk information 202 is not necessarily stored in the Log file 106 in the Offset 302 sequence.

The CSIndex file 103 corresponds to the CS file 104 on a one-to-one basis, and comprises information for accessing Chunk data 320 stored in the CS file 104. The CSIndex file 103, for example, is stored in the second FS 42 under a filename 201c such as “‘ChunkSetID’.ctl”. Therefore, a corresponding CSIndex file 103 can be identified from the ChunkSetID 304 of each piece of Chunk information 202 in the CT file 102. The CSIndex file 103 comprises a FP 305, a D-Offset 311, and a D-Length 312 as data items for each Chunk data 320. Information comprising these data items 305, 311, and 312 will be referred to as D-Chunk information 203. The FP 305 is the same as that described above, and as such, an explanation will be omitted.

The D-Offset 311 is information showing a location (for example, an address value) in the CS file 104 of Chunk data 320 corresponding to the relevant D-Chunk information 203.

The D-Length 312 is information showing the data size of Chunk data 320 corresponding to the relevant D-Chunk information 203.

The CS file 104 corresponds with the CSIndex file 103 on a one-to-one basis, and stores a prescribed number of Chunk data 320. The CSIndex file 103, for example, is stored in the second FS 42 under a filename 201d such as “‘ChunkSetID’.ctt”. The CS file 104 comprises a D-Length 312 and Chunk data 320 as data items for each Chunk.

The D-Length 312 shows the data size of the Chunk data 320 following this D-Length 312. The value of this D-Length 312 is the same as the value of the D-Length 312 of the above-described CSIndex file 103. This D-Length 312 is used when restoring the CSIndex file 103.

The Chunk data 320 is the data resulting from having partitioned the source file. That is, the source file can be reconfigured by joining this Chunk data 320 in the proper sequence.

The duplicate management file 105 is used in a duplicate removal process when migrating Chunk data 320. That is, the same data as the Chunk data 320 managed by this duplicate management file 105 is not migrated to the second FS 42. The duplicate management file 105 collectively manages FPs 305 having identical parts. This duplicate management file 105, for example, is stored in the second FS 42 under a filename 201e such as “‘Partial FingerPrint’.part”. That is, the duplicate management file 105, for example, is stored in the second FS 42 under the filename 201e “8e29. part” using the four characters “8e29” from the start of the FP 305 shown in FIG. 5. The duplicate management file 105 comprises a FP 305 and a ChunkSetID 304 as data items for each Chunk data 320. Information comprising these data items 305 and 304 will be referred to as O-Chunk information 204 hereinbelow.

The ChunkSetID 304 and the FP 305 are the same as described above, and as such, explanations will be omitted. Furthermore, the prescribed part of this FP 305 is identical to the prescribed part of the filename 201e in the duplicate management file 105 comprising this FP 305.

The backup file 107 comprises attribute information related to a directory and a file stored in the second FS 42. The backup file 107 is used in a Stub file 101 restoration process. The backup file 107, for example, is stored in the second FS 42 under a filename 201g such as “‘ContentID’.bk”. The backup file 107 comprises a ContentID 301 and a first Content attribute 331 as data items for each file. The ContentID 301 is the same as was described above, and as such, an explanation will be omitted. The first Content attribute 331, for example, comprises information, such as whether the file shown by the ContentID 301 is a directory or a file, and where it is located in the directory hierarchy.

The custom metafile 108 comprises information related to a file stored in the second FS 42. The custom metafile 108 is used in a restoration process for a Stub file 101. The custom metafile 108, for example, is stored in the second FS 42 under a filename 201h such as “‘ContentID’.cm”. The custom metafile 108 has a one-to-one corresponding relationship with the above-described backup file 107. The custom metafile 108 comprises a ContentID 301 and a Second Content attribute 332 as data items for each file. The ContentID 301 is the same as was explained hereinabove, and as such, an explanation will be omitted. The Second Content attribute 332, for example, comprises information, such as timestamps for file creation and updating, and an access control. Next, the explanation will return to FIG. 3, and the respective functions will be explained.

The controller 12 comprises a write processing part 51, a read processing part 52, a Stub restoration processing part 53, a CT restoration processing part 54, a CSIndex restoration processing part 55, and a duplicate management restoration processing part 56. The respective function blocks will be explained below.

The write processing part 51, in accordance with the following processing, writes data to the FS configured on the storage device group 33 of the disk array 14. The write processing part 51, upon receiving a file write request from the host 50 or the like, first writes this file to the first FS 41. Then, the write processing part 51 partitions the file, which has been written to the first FS 41, into prescribed multiple Chunk data 320. The write processing part 51 then performs a duplicate determination for each of the multiple Chunk data 320 to see whether or not identical Chunk data 320 exists in the second FS 42. In a case where identical Chunk data 320 does not exist in the second FS 42 in this duplicate determination, the write processing part 51 migrates this Chunk data 320 to the second FS 42. Alternatively, in a case where an identical piece of Chunk data 320 does exist in the second FS 42, the write processing part 51 does not migrate this piece of Chunk data 320 to the second FS 42.

The write processing part 51 also performs a duplicate determination as to whether or not there is identical Chunk data 320 based on the FP 305 uniquely computed from the Chunk data 320 (also referred to as a Chunk data computation value). The FP 305, for example, is a hash value computed from the Chunk data 320 using a prescribed hash function. The write processing part 51, in a case where an FP 305, which is identical to this computed FP 305, exists in the duplicate management file 105, determines that the same Chunk data 320 exists in the second FS 42. Alternatively, in a case where an identical FP 305 does not exist in the duplicate management table 105, the write processing part 51 determines that identical Chunk data 320 does not exist in the second FS 42. The relevant processing will be explained in detail further below.

Furthermore, as was shown in FIG. 4, the duplicate management file 105 manages FPs having the same prescribed part value as a single file. Therefore, in the duplicate determination, the write processing part 51 first searches as to whether or not there exists a duplicate management file in which prescribed parts (for example, the four characters from the start) of the hash values of Chunk data 320 are identical, and in a case where such a duplicate management file 105 does not exist, may determine that there is no duplication. This makes it possible to perform the duplicate determination faster.

The read processing part 52, in accordance with the following processing, reads data from the FS configured on the storage device group 33 of the disk array 14. The read processing part 52, upon receiving a request from the host 50 or the like to the effect read a file, identifies whether this file exists in either the first FS 41 or the second FS 42. That is, the read processing part 52, in a case where this file is still stored in the first FS 41 and has yet to be migrated to the second FS 42 (that is, a case in which this file is cached in the first FS 41), reads this file from the first FS 41. Alternatively, in a case where this file has already been migrated to the second FS 42 (that is, a case in which this file is not cached in the first FS 41), the write processing part 51 identifies a corresponding CT file 102 based on the ContentID 301 of the Stub file 101 stored in the first FS 41. Next, the read processing part 52, based on the Chunk information 202 of the CT file 102, reconfigures the source file by joining together multiple Chunk data 320 stored in the second FS 42, and copies this reconfigured source file to the first FS 41. Next, the read processing part 52 reads the file, which has been copied to the first FS 41, and returns this file to the host 50. The relevant processing will be explained in detail further below.

The Stub restoration processing part 53 executes a Stub file 101 restoration process in a case where either a failure resulting in corruption or loss has occurred in the Stub file 101, or there has been a restoration instruction from the user. The Stub file 101 can be restored using the backup file 107 and the custom metafile 108. Next, an overview of Stub restoration processing will be explained.

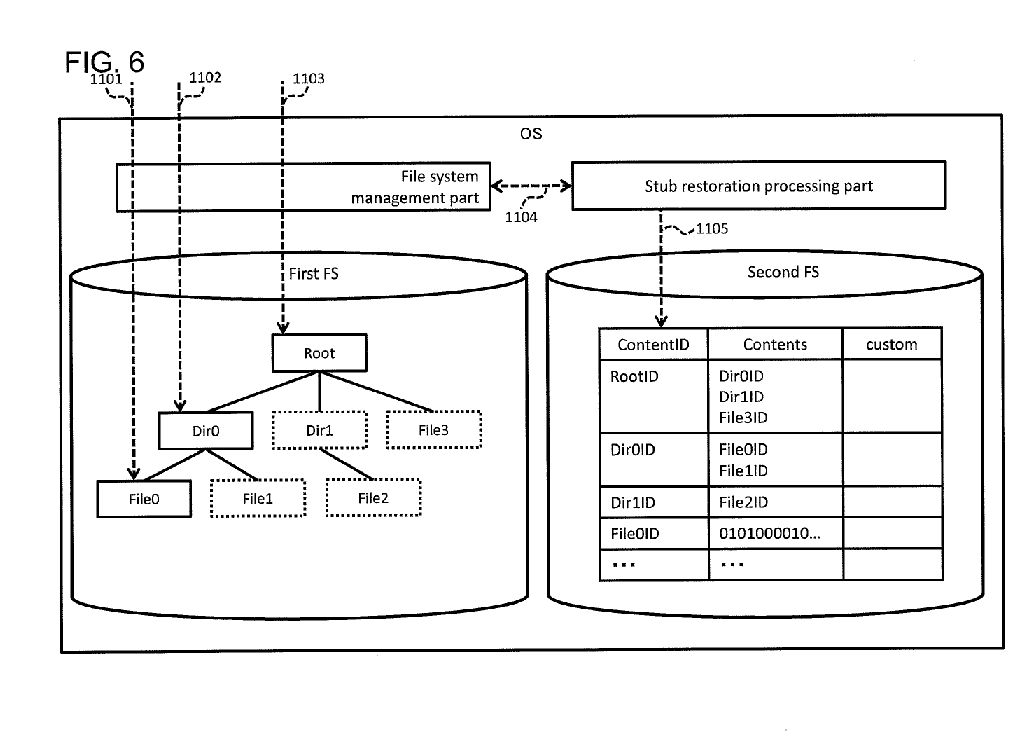

FIG. 6 is a schematic diagram for illustrating a Stub restoration process.

The Stub restoration processing part 53, for example, upon receiving a Stub restoration instruction from the user (1103), restores a dummy sub-mount point (that is, a Root) directory and a dummy file to the first FS 41. That is, the Stub restoration processing part 53 restores a directory and a file, which do not possess attribute information, to the first FS 41. The attribute information, for example, is directory mapping information, Stub information, and/or the data itself. In addition, in a case where there was an access to either the dummy directory or the dummy file (1101, 1102), the Stub restoration processing part 53 identifies the backup file 107 and the custom metafile 108 corresponding to this directory or file (1105). Then, the Stub restoration processing part 53 acquires the ContentID 301 and the Content attribute information corresponding to this directory or file from these identified backup file 107 and custom metafile 108 (1104), and restores the Stub file 101. The explanation will return to FIG. 5 below.

The CT restoration processing part 54 restores a CT file 102 for which a failure has occurred. As described hereinabove, the CT file 102 and the Log file 106 have a one-to-one corresponding relationship due to filenames 201b, 201f having the same ContentID 301. Therefore, the CT restoration processing part 54 can use the Log file 106 to restore the CT file 102 as follows. That is, the CT restoration processing part 54 outputs a ChunkSetID 304 and a FP 305 corresponding to each Chunk data to the Log file 106 at the time of a migration process. Then, in a case where a failure occurs in the CT file 102, the CT restoration processing part 54 restores the CT file 102 on the basis of the log file 106. The relevant processing will the explained in detail further below.

The CSIndex restoration processing part 55 restores a CSIndex file 103 in which a failure has occurred. As described hereinabove, the CSIndex file 103 and the CS file 104 have a one-to-one corresponding relationship due to filenames 201c, 201d having the same ChunkSetID 304. Therefore, the CSIndex restoration processing part 55 can use the CS file 104 to restore the CSIndex file 103 as follows. That is, in a case where a failure has occurred in the CSIndex file 103, the CSIndex restoration processing part 55 identifies the CS file 104 to which the same ChunkSetID 304 as that of the relevant CSIndex file 103 has been assigned. Then, the CSIndex restoration processing part 55 restores the relevant CSIndex file 103 by computing the FPs 305 of the respective Chunk data 320 included in the identified CS file 104. The relevant processing will be explained in detail further below.

The duplicate management restoration processing part 56 restores a duplicate management file 105 in which a failure has occurred. The duplicate management restoration processing part 56 can use the CT file 102 to restore the duplication management file 105 as follows. That is, in a case where a failure has occurred in the duplicate management file 105, the duplicate management restoration processing part 56 restores all the duplicate management files 105 on the basis of the ChunkSetID 304 and FP 305 included in the CT file 102 by combining CT files 102 in which the FP 305 prescribed parts have the same value into a single duplicate management file 105. The relevant processing will be explained in detail further below.

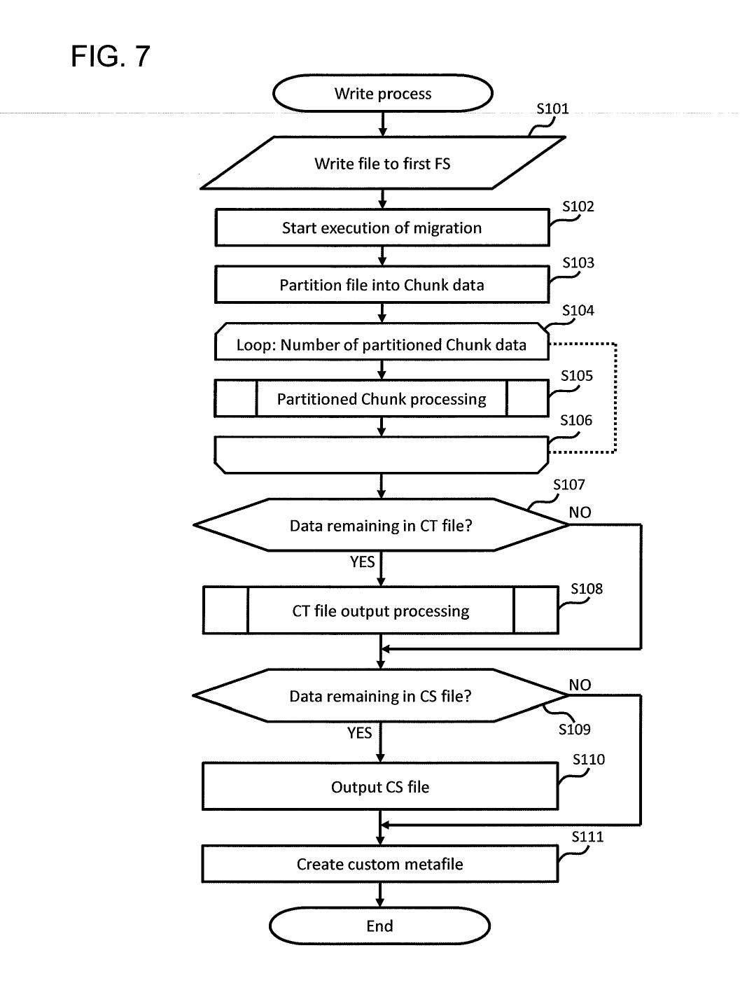

FIG. 7 is a flowchart showing an example of write processing. The processing of the write processing part 51 will be explained in more detail below using FIGS. 7 through 9.

The write processing part 51, upon receiving a write request for a prescribed file from the host 50 or the like, writes this file to the first FS 41 (S101) and starts a migration at a prescribed timing (S102).

The write processing part 51 partitions the file into Chunk data 320 of a prescribed size (S103), and sequentially executes partitioned Chunk processing (S105) for each of these partitioned Chunk data 320. That is, the write processing part 51 repeats the processing of Steps S104 through 5106 in proportion to the number of partitioned Chunk data 320. Next, the partitioned Chunk processing of this Step S105 will be explained in detail.

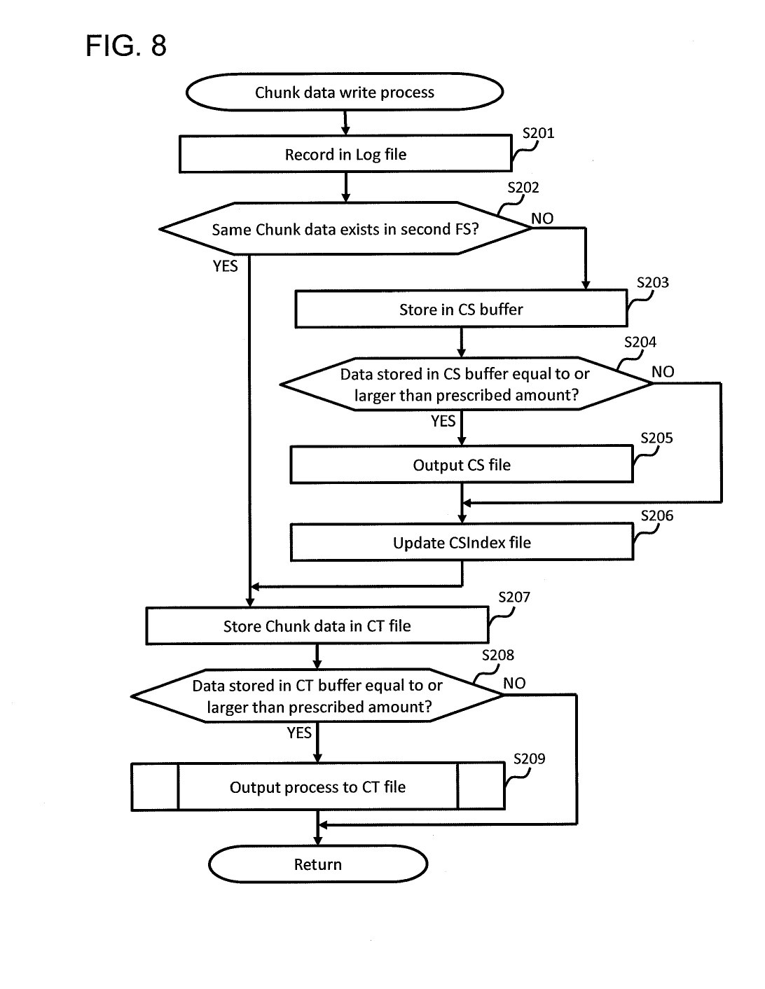

FIG. 8 is a flowchart showing an example of partitioned Chunk process.

The write processing part 51 records the Chunk information 202 of the migration-target Chunk data 320 in the Log file 106 (S201).

The write processing part 51 determines whether or not Chunk data 320, which is identical to the target Chunk data 320, already exists in the second FS 42 (S202).

In a case where identical Chunk data 320 exists in the second FS 42 (S202: YES), the write processing part 51 advances the processing to Step S207.

In a case where identical Chunk data 320 does not exist in the second FS 42 (S202: NO), the write processing part 51 stores the target Chunk data 320 in a CS buffer (S203). Then, the write processing determines whether or not the amount of data stored in the CS buffer has become equal to or larger than a prescribed value (for example, equal to or larger than the maximum number of Chunk data 320 capable of being stored in a single CS file 104) (S204).

In a case where the amount of data stored in the CS buffer is not equal to or larger than a prescribed value (S204: NO), the write processing part 51 advances the processing to Step S206.

In a case where the amount of data stored in the CS buffer has become equal to or larger than the prescribed value (S204: YES), the write processing part 51 adds the Length 303 and outputs the Chunk data 320 being stored in the CS buffer to the CS file 104 (S205), and advances the processing to Step S206.

In Step S206, the write processing part 51 records the D-Chunk information 203 corresponding to the target Chunk data 320 in the CSIndex file 103 (S206), and advances the processing to Step S207.

In Step S207, the write processing part 51 stores the Chunk information 202 corresponding to the target Chunk data 320 in a CT buffer (S207).

The write processing part 51 determines whether or not the amount of data stored in the CT buffer has become equal to or larger than a prescribed value (for example, equal to or larger than the maximum number of pieces of Chunk information 202 capable of being stored in a single CT file 102) (S208).

In a case where the amount of data stored in the CT buffer is not equal to or larger than a prescribed value (S208: NO), the write processing part 51 returns to the processing of the invoker.

In a case where the amount of data stored in the CT buffer has become equal to or larger than the prescribed value (S208: YES), the write processing part 51 executes an output process to the CT file (S209), and thereafter, returns to the processing of the read source. Next, the output process to the CT file of this Step S209 will be explained in more detail.

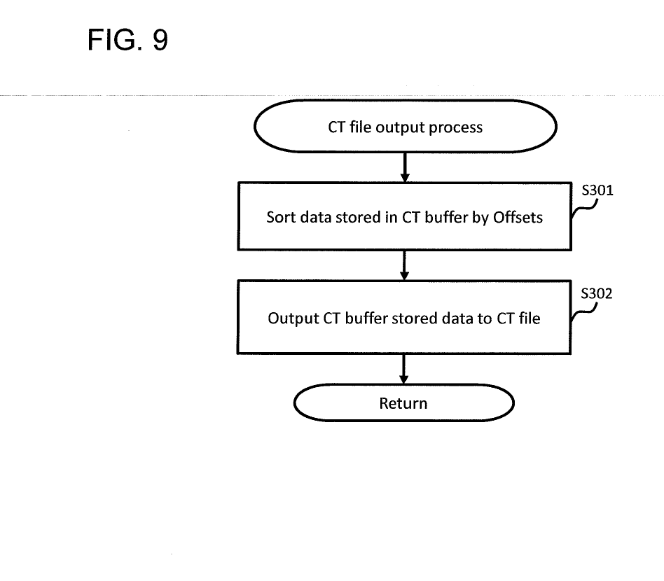

FIG. 9 is a flowchart showing an example of the output process to the CT file.

The write processing part 51 sorts the Chunk information 202 stored in the CT buffer in Offset 302 sequence (S301).

The write processing part 51 outputs the sorted Chunk information 202 stored in the CT buffer to the CT file 102 (S302), and returns to the processing of the invoker.

The explanation will return to FIG. 7 and continue with the Step S107 and beyond.

The write processing part 51 determines whether or not data still remains in the CT buffer (S107). That is, the write processing part 51 determines whether or not data not outputted to the CT file 102 in accordance with the processing of Steps S208 and S209 still remains in the CT buffer.

In a case where no data remains in the CT buffer (S107: NO), the write processing part 51 advances the processing to Step S109.

In a case where data remains in the CT buffer (S107: YES), the write processing part 51 outputs the data remaining in the CT buffer to the CT file 102 in accordance with the output processing to the CT file shown in the above-described FIG. 9 (S108), and advances the processing to Step S109.

In Step S109, the write processing part 51 determines whether or not data remains in the CS buffer (S109). That is, the write processing part 51 determines whether or not data not outputted to the CT file 102 in accordance with the processing of Steps S204 and S205 still remains in the CT buffer.

In a case where no data remains in the CS buffer (S109: NO), the write processing part 51 advances the processing to Step S111.

In a case where data remains in the CS buffer (S109: YES), the write processing part 51 outputs the data remaining in the CS buffer to the CS file 104 (S110), and advances the processing to Step S111.

In Step S111, the write processing part 51 creates a custom metafile 108 (S111) and ends the relevant processing.

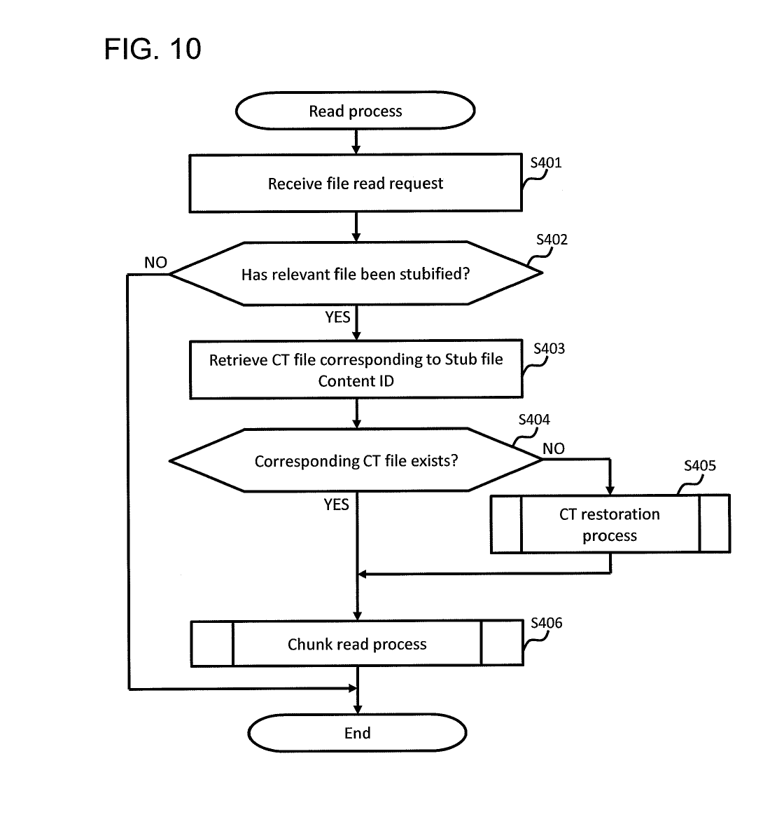

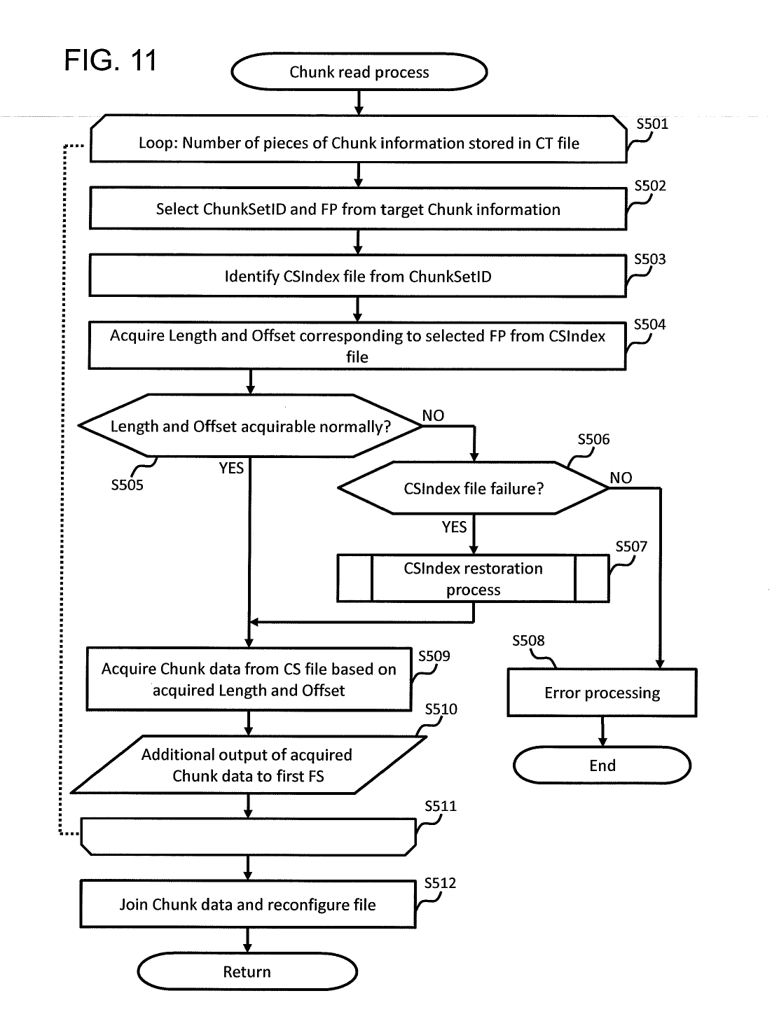

FIG. 10 is a flowchart showing an example of read processing. The processing of the read processing part 52 will be explained in more detail below using FIGS. 10 and 11.

The read processing part 52, upon receiving a read request for a prescribed file from the host 50 or the like (S401), determines whether or not this file has been stubified (S402).

In a case where this file has not been stubified (S402: NO), the read processing part 52 ends the relevant processing.

In a case where this file has been stubified (S402: YES), the read processing part 52 identifies the ContentID 301 from the Stub file 101 comprising the filename of this file, and retrieves the CT file 102 comprising the filename 201b of this ContentID 301 (S403).

Then, the read processing part 52 determines whether or not a CT file 102 comprising this ContentID 301 exists (S404).

In a case where a corresponding CT file 102 does not exist (S404: NO), the read processing part 52 determines that a failure has occurred in the CT file 102, and executes a CT restoration process, which will be described further below (S405). Then, the read processing part 52, after restoring the CT file 102, advances the processing to Step S406.

In a case where the corresponding CT file 102 does exist (S404: YES), the read processing part 52 advances the processing to Step S406 as-is.

In Step S406, the read processing part 52 executes Chunk read processing (S406), and ends the relevant processing. Next, the Chunk read processing of Step S406 will be explained in more detail.

FIG. 11 is a flowchart showing an example of a Chunk read process.

The read processing part 52 sequentially executes the processing of Steps S501 through S511 with respect to each piece of Chunk information 202 stored in the CT file 102 retrieved in Step S403. That is, the read processing part 52 repeats Steps S501 through S511 in proportion to the number of pieces of Chunk information 202 stored in the CT file 102 retrieved in Step S403.

The read processing part 52 selects Chunk information 202 from the CT file 102 as a processing target, and selects the ChunkSetID 304 and the FP 305 included in this target Chunk information 202 (S502).

The read processing part 52 identifies a CSIndex file 103 comprising the same filename 201c as the selected ChunkSetID 304 (S503).

The read processing part 52 identifies, on the basis of the identified CSIndex file 103, the D-Chunk information 203 comprising the FP 305 selected in Step S502, and acquires the Offset 302 and the Length 303 included in the identified D-Chunk information 203 (S504). Then, the read processing part 52 determines whether or not the Offset 302 and the Length 303 were able to be acquired normally (S505).

In a case where acquisition could be performed normally (S505: YES), the read processing part 52 advances the processing to Step S509.

In a case where acquisition could not be performed normally (S505: NO), the read processing part 52 determines whether or not there is a failure in the CSIndex file 103 (S506).

In a case where there is not a failure in the CSIndex file 103 (that is, the error was caused by something else) (S506: NO), the read processing part 52 executes a prescribed error process (S508) and ends the relevant processing.

In a case where it is a failure of the CSIndex file 103 (S506: YES), the read processing part 52 executes a CSIndex restoration process (S507), which will be described further below. Then, after restoring the CSIndex file 103, the read processing part 52 advances the processing to Step S509.

In Step S509, the read processing part 52 acquires Chunk data 320 from the CS file 104 based on the Offset 302 and the Length 303 acquired in Step S504 (S507).

The read processing part 52 performs an additional output of the acquired Chunk data 320 to the first FS 41 (S510).

The read processing part 52 reconfigures the file by joining the multiple Chunk data 320 additionally outputted to the first FS 41 in accordance with loop processing of Steps S501 through S511 (S512), and ends the relevant processing.

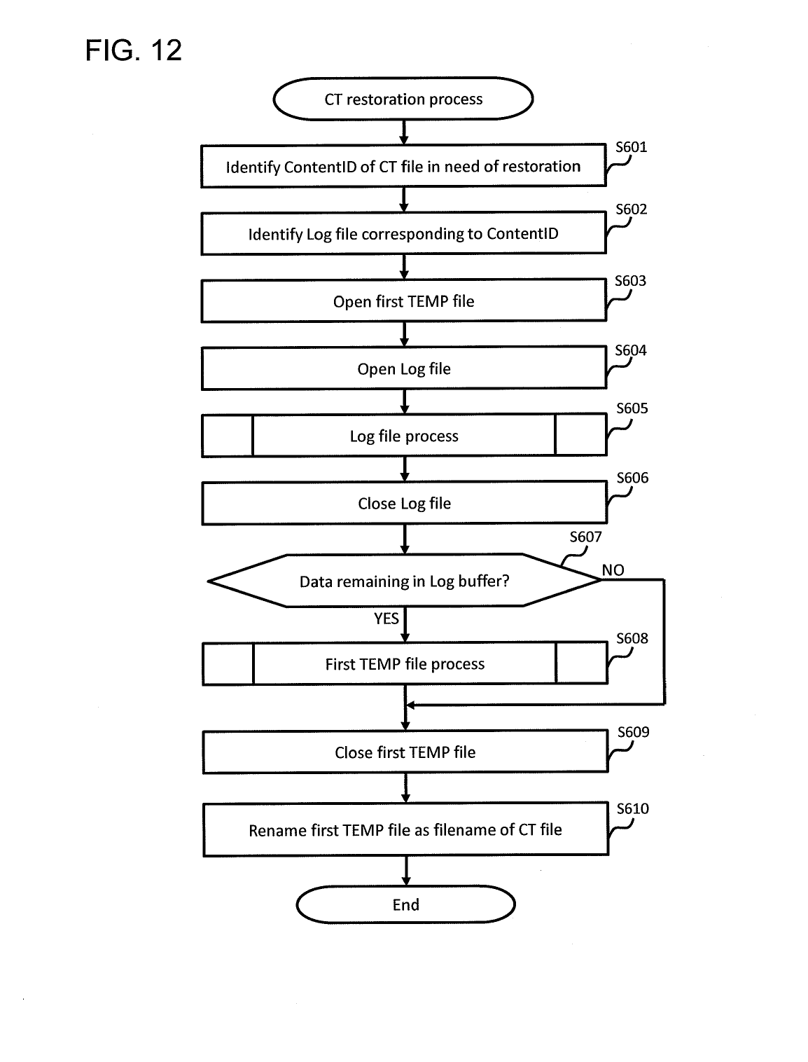

FIG. 12 is a flowchart showing an example of a CT restoration process. The CT restoration process is executed in a case where either a failure has occurred in the CT file 102, or there has been a restoration instruction from the user. The processing of the CT restoration processing part 54 will be explained in detail below using FIGS. 12 through 14.

The CT restoration processing part 54 identifies the ContentID 301 of the CT file 102 in need of restoration (S601). Then, the CT restoration processing part 54 identifies the Log file 106 comprising the same filename 201f as this ContentID 301 (S602).

The CT restoration processing part 54 opens a first TEMP file (S603). Then, the CT restoration processing part 54 opens the identified Log file 106 (S604).

The CT restoration processing part 54 executes a Log file process (S605). Next, the Log file processing of this Step S605 will be explained in detail.

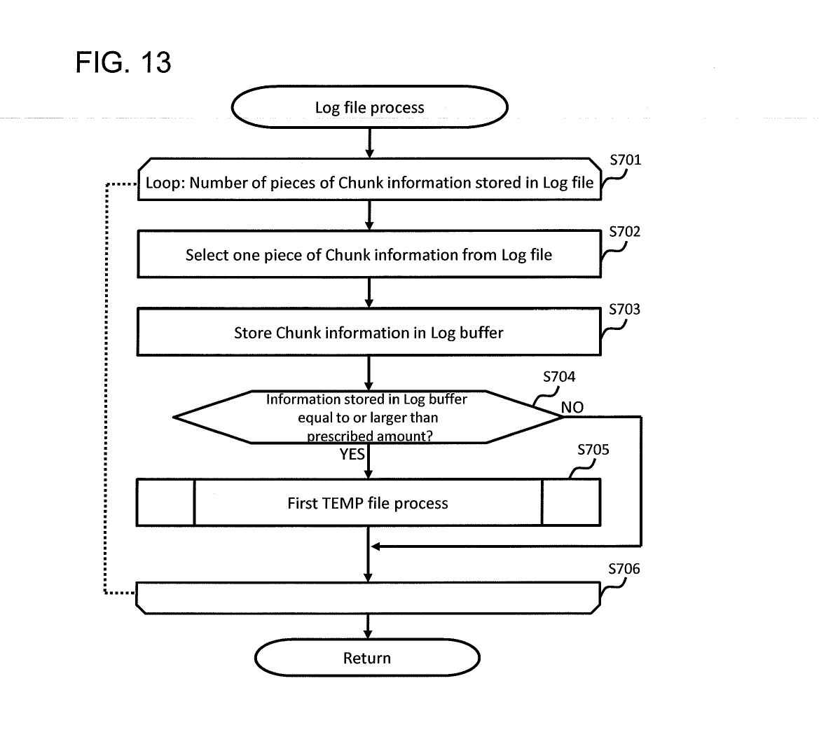

FIG. 13 is a flowchart showing an example of a Log file 106 process.

The CT restoration processing part 54 sequentially executes the processing of Steps S701 through S706 for each piece of Chunk information 202 stored in the relevant Log file 106 (S701). That is, the CT restoration processing part 54 repeats Steps S701 through S706 in proportion to the number of pieces of Chunk information 202 stored in the Log file 106.

The CT restoration processing part 54 selects Chunk information 202 from the Log file 106 as a processing target (S702). Then, the CT restoration processing part 54 stores this target Chunk information 202 in a Log buffer (S703).

The CT restoration processing part 54 determines whether or not the amount of data stored in the Log buffer is equal to or larger than a prescribed value (S704).

In a case where amount of data stored in the Log buffer is not equal to or larger than a prescribed value (5704: NO), the CT restoration processing part 54 advances the processing to Step S706.

In a case where amount of data stored in the Log buffer is equal to or larger than a prescribed value (S704: YES), the CT restoration processing part 54 executes a first TEMP file process (S705), which will be described further below, and thereafter, advances the processing to Step S706.

In Step S706, the CT restoration processing part 54, upon completing the relevant loop processing with respect to all the Chunk information 202, exits the relevant loop and returns the processing to the invoker. The first TEMP file processing of Step S705 will be explained in detail next.

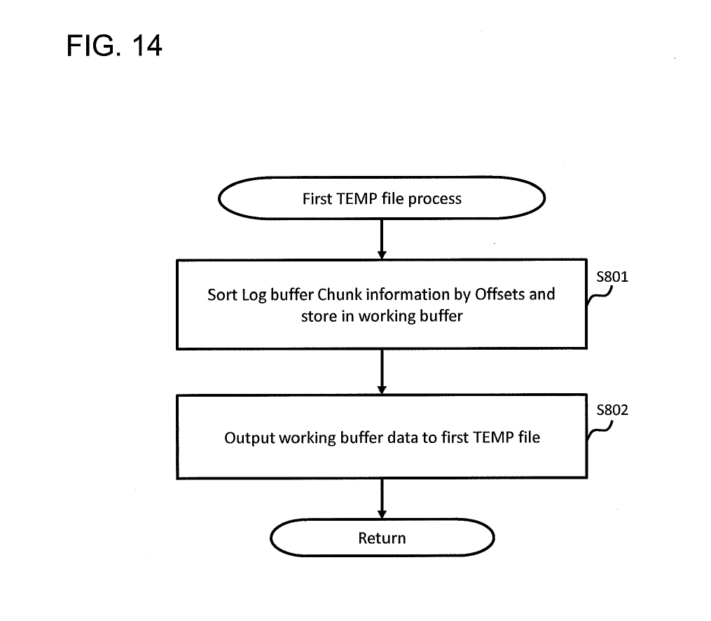

FIG. 14 is a flowchart showing an example of the first TEMP file process.

The CT restoration processing part 54 sorts the Chunk information 202 stored in the Log buffer in Offset 302 sequence, and stores the sorted Chunk information 202 in a working buffer (S801).

The CT restoration processing part 54 outputs the sorted Chunk information 202 stored in the working buffer to the first TEMP file (S802). Then, the CT restoration processing part 54 returns the processing to the read source.

The explanation will return to FIG. 12 hereinbelow, and continue from Step S608 and beyond. The CT restoration processing part 54 closes the Log file 106 (S608).

The CT restoration processing part 54 determines whether or not data remains in the Log buffer (S609).

In a case where no data remains in the Log buffer (S609: NO), the CT restoration processing part 54 advances the processing to Step S611.

In a case where data remains in the Log buffer (S609: YES), the CT restoration processing part 54 executes the first TEMP file process shown in FIG. 14 with respect to this remaining data (S610), and thereafter, advances the processing to Step S611.

In Step S611, the CT restoration processing part 54 closes the first TEMP file (S611). Then, the CT restoration processing part 54 renames the first TEMP file as the filename 201b of the restoration-target CT file 102 (S612), and ends the relevant processing. That is, the CT restoration processing part 54 replaces the failed CT file 102 with the first TEMP file.

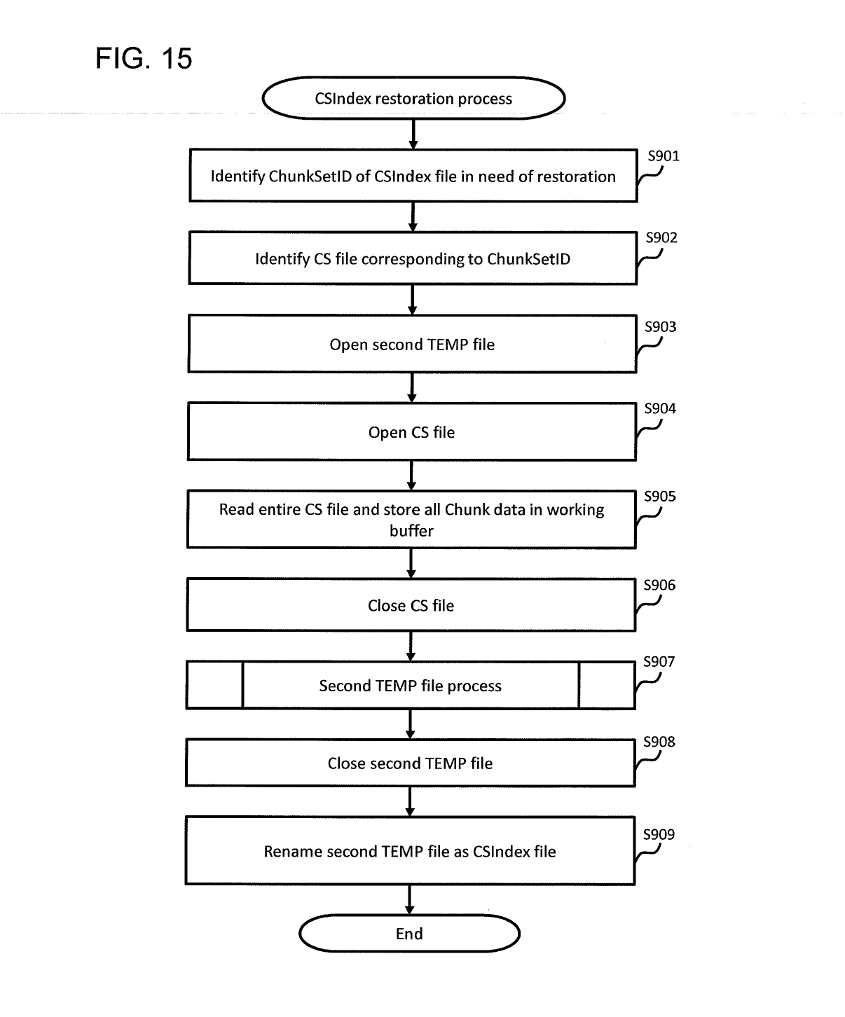

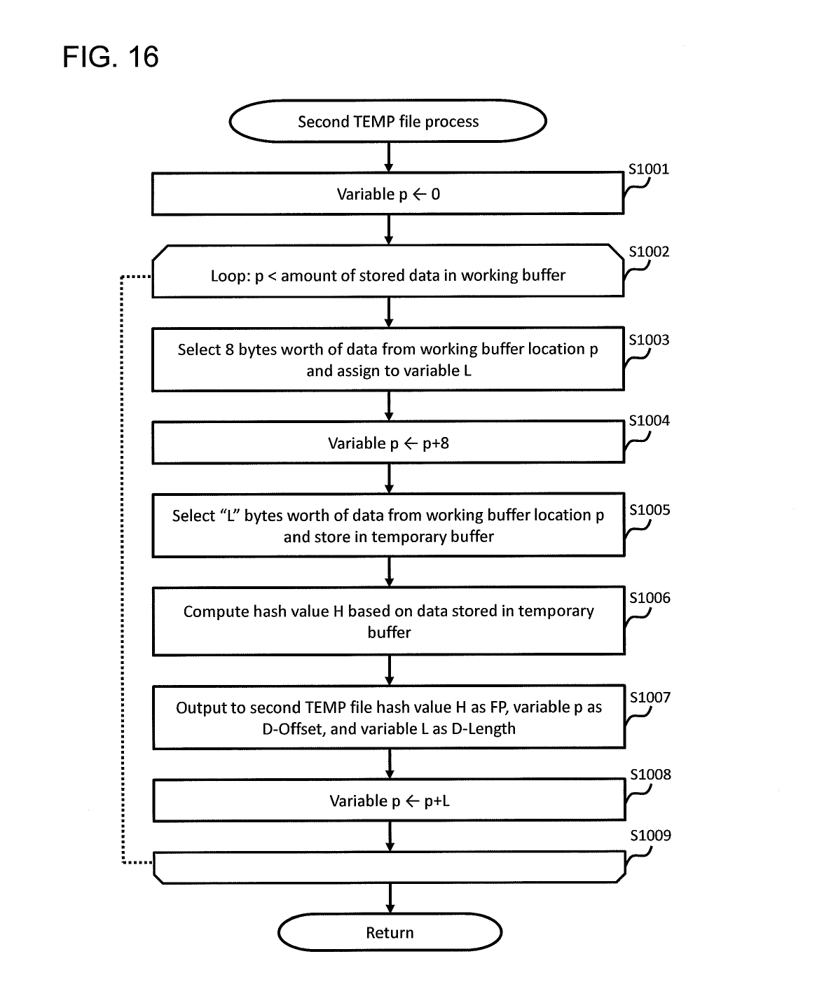

FIG. 15 is a flowchart showing an example of a CSIndex restoration process. The CSIndex restoration process is executed in a case where either a failure has occurred in the CSIndex file 103, or there has been a restoration instruction from the user. The processing of the CSIndex restoration processing part 55 will be explained in detail below using FIGS. 15 and 16.

The CSIndex restoration processing part 55 identifies the ChunkSetID 304 of the CSIndex file 103 in need of restoration (S901). Then, the CSIndex restoration processing part 55 identifies the CS file 104 comprising the same filename 201d as this ChunkSetID 304 (S902).

The CSIndex restoration processing part 55 opens a second TEMP file (S903). The CSIndex restoration processing part 55 opens the CS file 104 identified in Step S902 (S904).

The CSIndex restoration processing part 55 stores all the Chunk data 320 stored in the CS file 104 in a working buffer (S905). Then, the CSIndex restoration processing part 55 closes the CS file 104 (S906).

The CSIndex restoration processing part 55 executes a second TEMP file process (S907), which will be described further below. Then, the CSIndex restoration processing part 55 closes the second TEMP file (S908).

The CSIndex restoration processing part 55 renames the second TEMP file as the restoration-target CSIndex file 103 (S909), and ends the relevant processing. That is, the CSIndex restoration processing part 55 replaces the CSIndex file 103 in which the failure occurred with the second TEMP file. The second TEMP file processing of the above-mentioned Step S907 will be explained in detail below.

FIG. 16 is a flowchart showing an example of the second TEMP file process.

The CSIndex restoration processing part 55 assigns “0” to a variable p (that is, initializes the variable p) (S1001). The variable p shows the read location (for example, an address value) in the working file.

The CSIndex restoration processing part 55 repeats the processing of Steps S1001 through S1009 until the variable p becomes equal to or larger than the amount of data stored in the working buffer. That is, the CSIndex restoration processing repeats the processing of Steps S1001 through S1009 in proportion to the number of Chunk data 320 stored in the working buffer.

The CSIndex restoration processing part 55 selects 8-bytes (that is, the size of the D-Length 312) worth of data from the read location p in the working buffer, converts this data to an integer type, and assigns this integer type to a variable L (S1003). That is, the CSIndex restoration processing part 55 assigns the D-Length 312 value to the variable L.

The CSIndex restoration processing part 55 assigns “p+8” to the variable p (S1004). That is, the CSIndex restoration processing part 55 moves the read location of the working buffer to the start of the Chunk data 320 following the Length 303.

The CSIndex restoration processing part 55 selects “variable L” bytes worth of data from the working buffer location p, and stores this selected data in a temporary buffer (S1005). That is, the CSIndex restoration processing part 55 stores the Chunk data 320 following the Lenth in the temporary buffer.

The CSIndex restoration processing part 55 computes the hash value “H” of the data stored in the temporary buffer (S1006). That is, the CSIndex restoration processing part 55 computes the hash value of the Chunk data 320.

The CSIndex restoration processing part 55 additionally outputs to the second TEMP file the “hash value H” as the FP 305, the “variable p” as the D-Offset 311, and the “variable L” as the D-Length 312 (S1007).

The CSIndex restoration processing part 55 assigns “variable p+variable L” to the variable p (S1008). That is, the CSIndex restoration processing part 55 moves the read location of the working buffer to the start of the next Length 303.

The CSIdx restoration processing part, upon completing the processing of the Steps S1001 through S1009 with respect to all the Chunk data 320 stored in the working buffer, exits the relevant loop, and returns to the processing of the invoker.

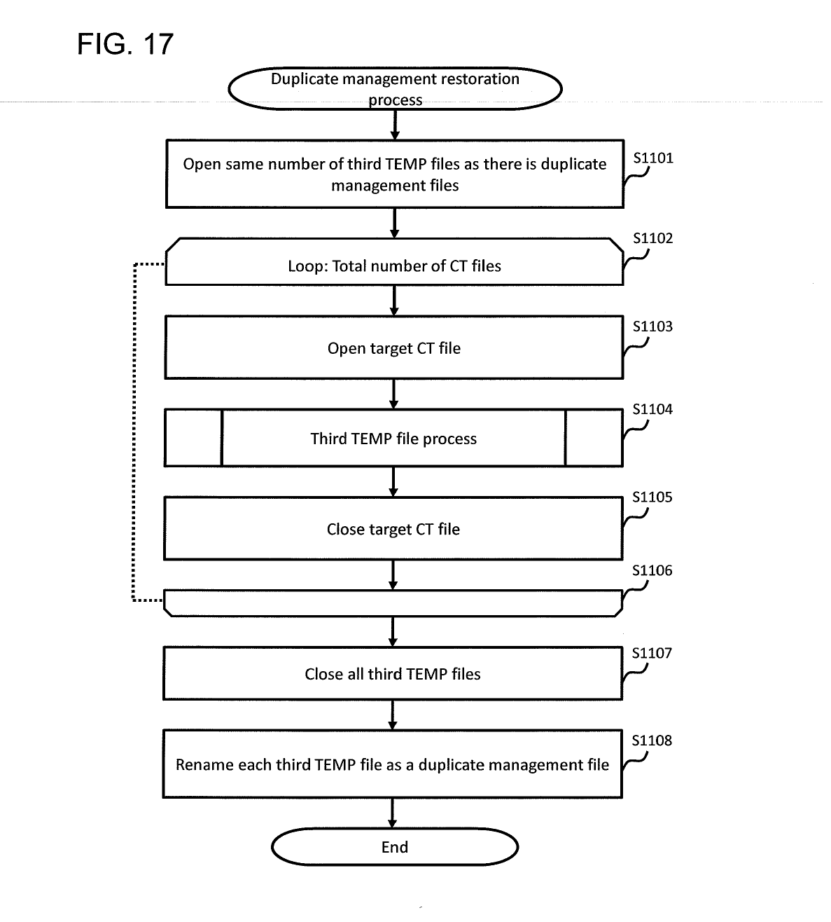

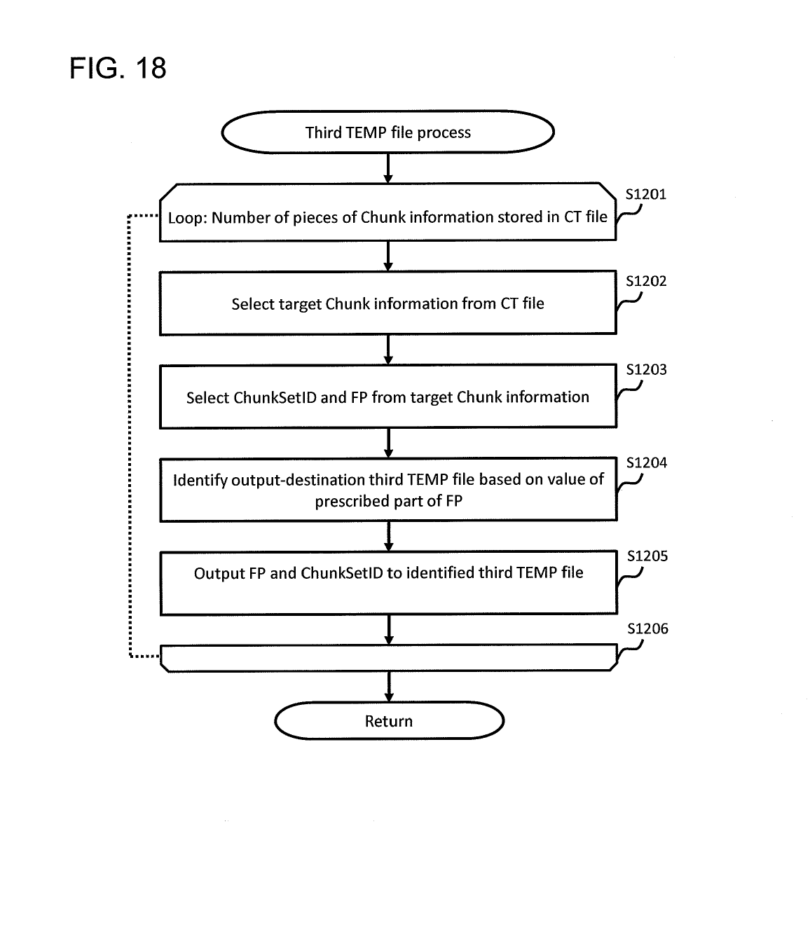

FIG. 17 is a flowchart showing an example of a duplicate management restoration process. The duplicate management restoration process is executed in a case where either a failure has occurred in the duplication management file 105, or there has been a restoration instruction from the user. The processing of the duplicate management restoration processing part 56 will be explained in detail below using FIGS. 17 and 18.

The duplicate management restoration processing part 56 opens the same number of third TEMP files as there are duplicate management files 105 stored in the second FS 42 (S1101).

The duplicate management restoration processing part 56 sequentially executes the processing of Steps S1102 through S1106 with respect to all the CT files 102 stored in the second FS 42. That is, the duplicate management restoration processing part 56 repeats the processing of Steps S1102 through S1106 in proportion to the number of CT files 102 stored in the second FS 42.

The duplicate management restoration processing part 56 opens a CT file 102 as the processing target of the relevant loop (S1103). That is, the duplicate management restoration processing part 56 executes a third TEMP file process (S1104), which will be described further below. Then, the duplicate management restoration processing part 56 closes the CT file 102 opened in Step S1103 (S1105).

The duplicate management restoration processing part 56, upon completing the processing of Steps S1102 through S1106 for all the CT files 102, advances the processing to the next Step S1107.

The duplicate management restoration processing part 56 closes all the third TEMP files opened in the above-mentioned Step S1001 (S1107). Then, the duplicate management restoration processing part 56 renames the filenames of all of the third TEMP files as the filenames 201e of the respectively corresponding duplicate management files 105 (S1108). That is, the duplicate management restoration processing part 56 replaces the failed duplicate management files 105 with the third TEMP files. Next, the third TEMP file processing of Step S1104 will be explained in detail.

FIG. 18 is a flowchart showing an example of the third TEMP file process.

The duplicate management restoration processing part 56 sequentially executes the processing of Steps S1201 through S1206 with respect to all the Chunk information 202 stored in the CT file 102 opened in Step S1103 (S1201). That is, the duplicate management restoration processing part 56 repeats the processing of Steps S1201 through S1206 in proportion to the number of pieces of Chunk information 202 stored in the CT file 102.

The duplicate management restoration processing part 56 selects Chunk information 202 from the CT file 102 as a processing target (S1202). The duplicate management restoration processing part 56 selects the ChunkSetID 304 and the FP 305 from the target Chunk information 202 (S1203).

The duplicate management restoration processing part 56 identifies an output-destination third TEMP file such that FPs 305 having the same partial value are stored in the same third TEMP file (S1204). Then, the duplicate management restoration processing part 56 additionally outputs the selected ChunkSetID 304 and FP 305 to this identified third TEMP file (S1205).

The duplicate management restoration processing part 56, upon completing the processing of Steps S1201 through S1206 for all the Chunk information 202 stored in the CT file 102, returns to the processing of the invoker.

According to this example, for example, the following effects are achieved.

1) Duplicate Chunk data 320 is not stored in the second FS 42, thereby making it possible to utilize the storage capacity of the second FS 42 efficiently.

2) Executing a duplicate removal process when a migration is to be executed at a prescribed timing makes it possible to hold in check a drop in the access response time with respect to the host 50. This is because most migrations are executed when the processing load on the storage apparatus 10 is low, so that even though a duplicate removal process, which has a relatively high processing load, has been executed, there is not much effect on the access response speed with respect to the host 50.

3) A Stub file 101, a CT file 102, a CSIndex file 103, and a duplicate management file 105 can be restored even when a failure has occurred in these files. That is, the fault tolerance of the storage apparatus 10 can be elevated.

The example described hereinabove is an example for illustrating the present invention, and does not purport to limit the scope of the present invention solely to these examples. A person having ordinary skill in the art will be able to put the present invention into practice using a variety of other modes without departing from the gist of the present invention.

For example, either all or a portion of the CT file 102, the CSIndex file 103, the CS file 104, the duplicate management file 105, the Log file 106, the backup file 107, and the custom metafile 108 may be stored in another storage device. Then, the controller 12 may access these files stored in another device, and may write data to the second FS 42 and read data from the second FS 42.

### REFERENCE SIGNS LIST

12 Controller
50 Host
41 First file system
42 Second file system
101 Stub file
102 ContentTable file
103 ContentSetIndex file
104 ContentSet file
105 Duplicate management file
106 Log file

1. A storage apparatus, comprising:
a first file system;
a second file system;
duplicate management information, which stores a second data computation value uniquely computed from the second data, wherein the duplicate management information manages a part, which has a value identical to that of a prescribed part of the second data computation value, as one duplicate management set; and
a controller for controlling the first file system and the second file system,
wherein the controller:
(A) executes a duplication determination, which is a determination as to whether or not a second data, which is identical to a first data stored in the first file system, exists in the second file system in a case where a migration process for migrating the first data to the second file system is to be performed, wherein the first data and the second data are single chunks of partitioned data obtained by partitioning prescribed file data into multiple chunks;
(B) executes the migration process in a case where the result of the duplication determination in (A) is negative;
(C) does not execute the migration process in a case where the result of the duplication determination in (A) is affirmative; and
(D) executes the duplication determination as a process for determining whether or not the second data computation value, which is identical to a first data computation value uniquely computed from the first data, exists in the duplicate management information, and
wherein the controller:
executes the migration process of (B) in a case where the determination in (D) is negative; and
does not execute the migration process of (C) in a case where the determination of (D) is affirmative;
(E) determines in (D) whether or not the duplicate management set, which has a value identical to that of a prescribed part of the first data computation value, exists in the duplicate management information;
in a case where the determination in (E) is negative, executes the migration process of (B); and
in a case where the determination of (E) is affirmative,
(F) determines whether or not the second data computation value, which is identical to the first data computation value, exists in the duplicate management set; and
executes the migration process of (B) in a case where the determination in (F) is negative, and does not execute the migration process of (C) in a case where the determination in (F) is affirmative.

2. (canceled)

3. (canceled)

4. (canceled)

5. A storage apparatus according to claim 1, comprising:
data configuration information for storing a corresponding relationship between partition location information of the second data and the second data computation value in a sequence of partition locations of the second data in a prescribed file data; and
log information for storing a corresponding relationship between the second data partition location information and the second data computation value in a sequence constituting the migration process targets,
wherein the controller, in a case where a failure has occurred in the data configuration information, restores the data configuration information by sorting the corresponding relationships stored in the log information in partition location sequence.

6. A storage apparatus according to claim 1, comprising:
a data set for managing the multiple second data as a set; and
a data computation value set for managing as a set the second data computation value of the second data managed in the data set,
wherein data set identification information corresponding to the data set and the data computation value set is provided, and
the controller, in a case where a failure has occurred in the data computation value set, identifies a data set corresponding to data set identification information provided in the relevant data computation value set, and restores the data computation value set by computing a second data computation value of the second data included in this the data set.

7. A storage apparatus according to claim 5, wherein the controller, in a case where a failure has occurred in the duplication management information, selects the multiple first data computation values from the data configuration information, and restores the duplicate management information by treating the first data computation values, which comprise values identical to those of a prescribed part, as one duplicate management set.

8. A storage apparatus according to claim 1, wherein the first data computation value and the second data computation value are hash values respectively computed from the first data and the second data based on a hash function.

9. A data storage method, comprising:
(A) executing a duplication determination, which is a determination as to whether or not a second data, which is identical to a first data stored in a first file system, exists in a second file system in a case where a migration process for migrating the first data to the second file system is to be performed;
(B) executing the migration process in a case where the result of the duplication determination in (A) is negative; and
(C) not executing the migration process in a case where the result of the duplication determination in (A) is affirmative
(D) executes the duplication determination as a process for determining whether or not the second data computation value, which is identical to a first data computation value uniquely computed from the first data, exists in the duplicate management information, and
wherein the controller:
executes the migration process of (B) in a case where the determination in (D) is negative; and
does not execute the migration process of (C) in a case where the determination of (D) is affirmative;
(E) determines in (D) whether or not the duplicate management set, which has a value identical to that of a prescribed part of the first data computation value, exists in the duplicate management information;
in a case where the determination in (E) is negative, executes the migration process of (B); and
in a case where the determination of (E) is affirmative,
(F) determines whether or not the second data computation value, which is identical to the first data computation value, exists in the duplicate management set; and
executes the migration process of (B) in a case where the determination in (F) is negative, and does not execute the migration process of (C) in a case where the determination in (F) is affirmative.
